(19) United States
(12) Patent Application Publication
(10) Pub. No.: US 2004/0177250 A1
(43) Pub. Date: Sep. 9, 2004

(54) Optimization for security certificates management

(76) Inventors: Cedric Westphal, San Francisco, CA (US); Hannu Flinck, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/757,434

(22) Filed: Jan. 15, 2004

Related U.S. Application Data
(60) Provisional application No. 60/451,664, filed on Mar. 5, 2003.

(51) Int. Cl. H04L 9/00

(52) U.S. Cl. 713/156

(57) ABSTRACT

A method, computer program for authenticating an entity in a communication network system and the entity itself. In the invention certificates of a first entity are provided which is to be authenticated by a second entity based on a certificate common to the first and second entities, the certificates of the first entity are classified as a function of probability that a second entity includes a given certificate, and in response to a certificate request by a second entity, the classified certificate with highest probability is submitted to the second entity.

The present application claims the benefit of priority of provisional application Serial No. 60/451,664, filed Mar. 5, 2003, the contents of which are incorporated herein by reference.

### FIELD OF THE INVENTION

The present invention relates to authentication of an entity in a communication network system.

### BACKGROUND OF THE INVENITON

Secure transactions are an increasing fraction of the Internet traffic. Terminals need to be able to establish secure connections for commerce and other applications. The IP (Internet Protocol) transport protocol being used for such secure transaction is TLS (Transport Layer Security).

According to TLS, one of the issues for a terminal or client and a serving entity or server of a communication network system is to agree on a common certificate. For example, as a mobile client carries less certificates than a regular client, the procedure to exchange certificates can become lengthy, since TLS is not optimized for use over the wireless interface.

In the Internet draft “Transport Layer Security Extensions,” TLS working group, July 2002, some extensions have been proposed to make TLS friendlier to the air interface, for example.

In order to find a certificate of the server which can be agreed upon by the client, according to the prior art, the possible certificates are exhausted in a trial-and-error process. According to an alternative prior art solution, the client is caused to send a list of its certificates to the server.

However, the first solution may entail long round-trip times, as the client and the server have to find a common certificate, and the second solution introduces security issues (for instance, if one of the certificate of the client is compromised, an attacker could take advantage of having a list of the client's certificates).

### SUMMARY OF THE INVENTION

It is an object of the present invention to improve authentication of an entity in a communication network system.

According to the present invention, this object is achieved by providing a method and computer program for authenticating an entity in a communication network system and the entity for use in the communication network for which authentication is to be conducted. The invention provides the advantage of minimizing the number of round trip times required to establish a secure connection between a terminal and a serving entity, i.e. to find a common certificate between a client and a server e.g. using TLS.

Moreover, besides optimizing the number of iterations needed to find a common certificate, the common certificate can be found without introducing security breaches.

Particularly the present invention provides a method and computer program for authenticating an entity in a communication network system. The method and computer program of the present invention provides certificates of a first entity to be authenticated by a second entity based on a certificate common to the first and second entities, classifies the certificates of the first entity as a function of probability that a second entity includes a given certificate, and in response to a certificate request by a second entity, submits the classified certificate with highest probability to the second entity.

Further, the present invention provides an entity of a communication network system. The entity of the present invention includes a storage for storing certificates of the entity to be authenticated by another entity of the communication network system based on a certificate common to both entities, first apparatus for classifying the certificates of the entity as a function of probability that another entity includes a given certificate, and second apparatus for, in response to a certificate request by another entity, submitting the classified certificate with highest probability to the other entity.

### BRIEF DESCRIPTION OF THE DRAWINGS

In the following, the present invention will be described in greater detail with reference to the appended drawings in which like reference numbers indicate same or similar elements.

FIG. 1 shows a flow chart illustrating an entity authentication process according to the present invention.

FIG. 2 shows a flow chart illustrating an entity authentication process according to the present invention in more detail.

FIG. 3 shows a flow chart illustrating an adaptable entity authentication process according to the present invention.

FIG. 4 shows a flow chart illustrating a group classification process according to an embodiment of the present invention.

FIG. 5 shows a schematic block diagram illustrating the structure of an entity for authenticating the entity according to the embodiment of the present invention.

FIG. 6 shows a signaling diagram illustrating an authentication process according to the embodiment of the present invention.

FIGS. 7A to 7E show classification states according to an example implementation of the embodiment of the present invention.

### DETAILED DESCRIPTION OF THE INVENTION

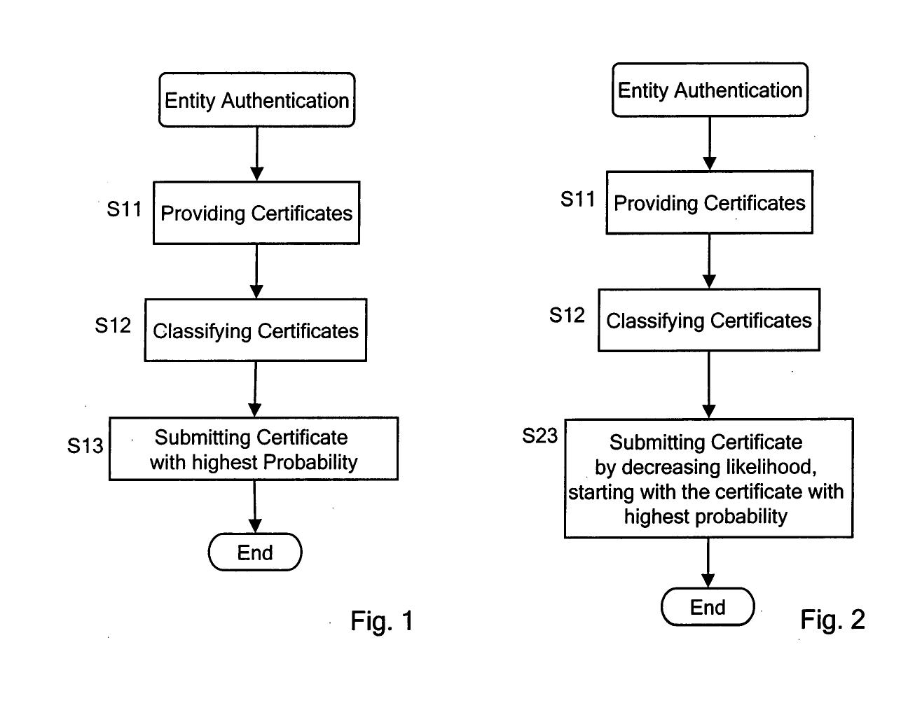

The basic idea of the present invention is shown in FIG. 1 illustrating a process of authenticating an entity in a communication network system. In step S11, certificates of an entity to be authenticated by another entity on the basis of a certificate common to both entities are provided. For example, the entity to be authenticated may be a device such as a serving device in the communication network system or simply a server. The entity to authenticate e.g. the server may be a terminal of the communication network system, such as a mobile terminal, or simply a client.

In step S12, the certificates of the first entity are classified as a function of probability that a client comprises a given certificate. Finally, in step S13, in response to a certificate request by a client, the classified certificate with highest probability is submitted to the client.

FIG. 2 shows the above-described authentication process in more detail. Steps S11 and S12 of FIG. 2 are the same as in FIG. 1. However, as indicated in step S23, when the server has to submit a certificate to a new client (i.e. upon a certificate request by the client) it submits it by decreasing likelihood, starting with the certificate with highest probability. In other words, in case the certificate with highest probability is not present in the client, at least one further classified certificate, i.e. the certificate with the second-highest probability, is submitted to the client. In case also this certificate is not present in the client, the certificate with the third-highest probability may be submitted to the client, and so on.

The probability that a client possesses a specific certificate may be known in advance or may have been tracked before the classification process in step S12. For this purpose, characteristics of clients may be used for classifying the certificates, which characteristics may then be assessed upon a certificate request by a client in order to submit the certificate with highest probability for these characteristics. Characteristics of clients may be, for example, whether the client is a mobile or fixed client, or whether the number of certificates the client possesses is large or small. Moreover, client characteristics may refer to geographical information or location, e.g. in which country the client resides, prefix information, e.g. home address prefix, or application information, e.g. using TLS through Internet Explorer or Netscape.

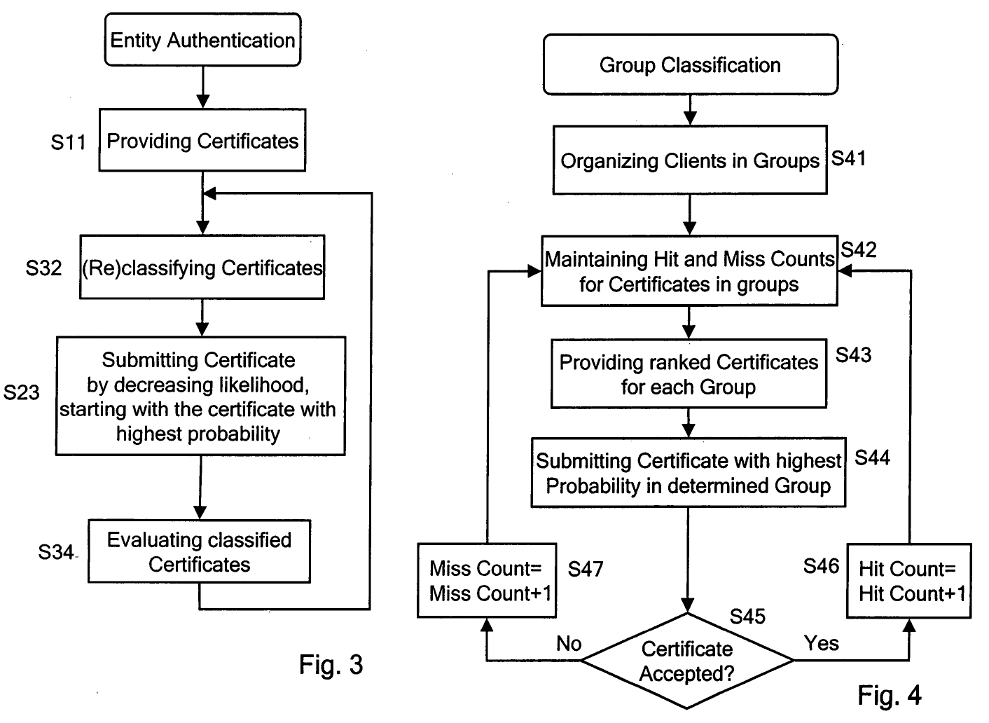

According to the present invention, the above-described authentication process may be made adaptable as shown in FIG. 3. According to step S34 in FIG. 3, classified certificates are evaluated on the basis of whether or not a submitted certificate is present in the client, and classification of the certificates is updated on the basis of the evaluation result as indicated in step S32. Hence, the present invention provides an adaptable authentication process which is able to learn a correct classification of certificates.

In the following, an embodiment of the adaptable authentication process according to the present invention will be described with reference to FIGS. 4 to 6.

FIG. 4 shows a group classification process according to the embodiment of the invention. For classifying the certificates of the server, in step S41 the server organizes the clients into behavior or characteristics groups such as, but not limited to, based on the mobility (fixed/mobile), and/or the number of certificates the client possesses (a few/a lot), and/or some geographical information or location (for instance, US vs. Europe vs. Asia) and/or some prefix information (for instance, home address prefix), and/or some application information (for instance, using TLS through IE vs. Netscape), and/or any other group classification.

As indicated in step S42, for each group, the server maintains with each certificate a hit and miss count for each entry in the group. From the hit and miss counts ranked certificates can be provided for each group as shown in step S43. If the server submits to a client belonging to given groups a certificate in step S44 that the client possesses (S45), then the hit count of each given group is increased (S46). If the client does not possess the certificate (S45), then the miss count in each given group is increased (S47). From this, the server can compute and rank the certificates based on the hit probability which is computed from the hit and miss counts. Alternatively, only a hit count or a miss count may be provided and the certificates may be computed or ranked on the basis of the hit count or miss count.

Whenever a new client attempts to authenticate the server, then the server may follow a policy rule to determine which group the client belongs to, and then provides certificates based on the certificate ranking within the group. For example, it may be assessed whether the client is a fixed or mobile client through its use of Mobile IP, and/or whether the number of certificates the client possesses is large or small, and/or some geographical information or location (for instance, US vs. Europe vs. Asia) and/or some prefix information (for instance, home address prefix), and/or some application information (for instance, using TLS through IE vs. Netscape) may be assessed. For example, this information is available in a HTTPS request of the client requesting a secure connection to the server which request would precede a TLS exchange if this exchange is prompted via a web browser. On the basis of this assessment it is determined to which group(s) the client belongs and on the basis of a policy rule a group out of these groups is determined and then certificates are provided based on the certificate ranking in this determined group.

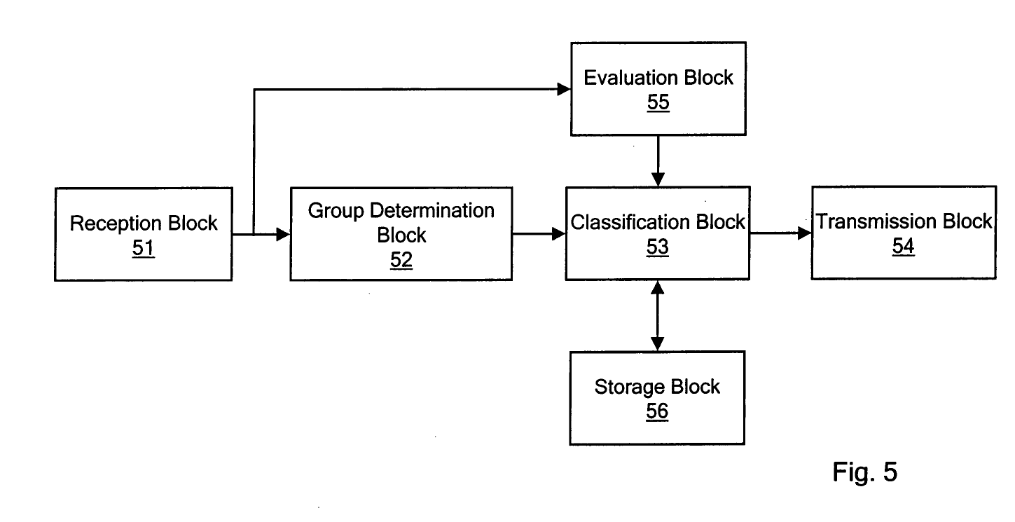

FIG. 5 shows a structure of the server for authenticating the server according to the embodiment of the invention. The server comprises a storage block 56 for storing certificates used for authentication by a client. Moreover, the server comprises a classification block 53 for classifying the certificates stored in the storage block 56 as a function of probability that a client comprises a given certificate. As described above the classification may be carried out by organizing clients in characteristics groups and, within each group, ranking the certificates by their likelihood of being present in a client belonging to the group. Finally, in response to a certificate request by a client, a transmission block 54 submits the classified certificate with highest probability to the client.

As shown in FIG. 5, the server also comprises a reception block 51 for receiving client requests and acknowledgments. In case of a certificate request by a client, in a group determination block 52 the group to which the client belongs can be determined on the basis of a policy rule and certificates may be provided based on the hit probability within this group as described above. In addition, an evaluation block 55 is able to evaluate whether the certificate transmitted by the transmission block 54 is appropriate, i.e. is present in the client requesting a certificate. As described above, according to the evaluation result the classification block 53 may update its certificate classification.

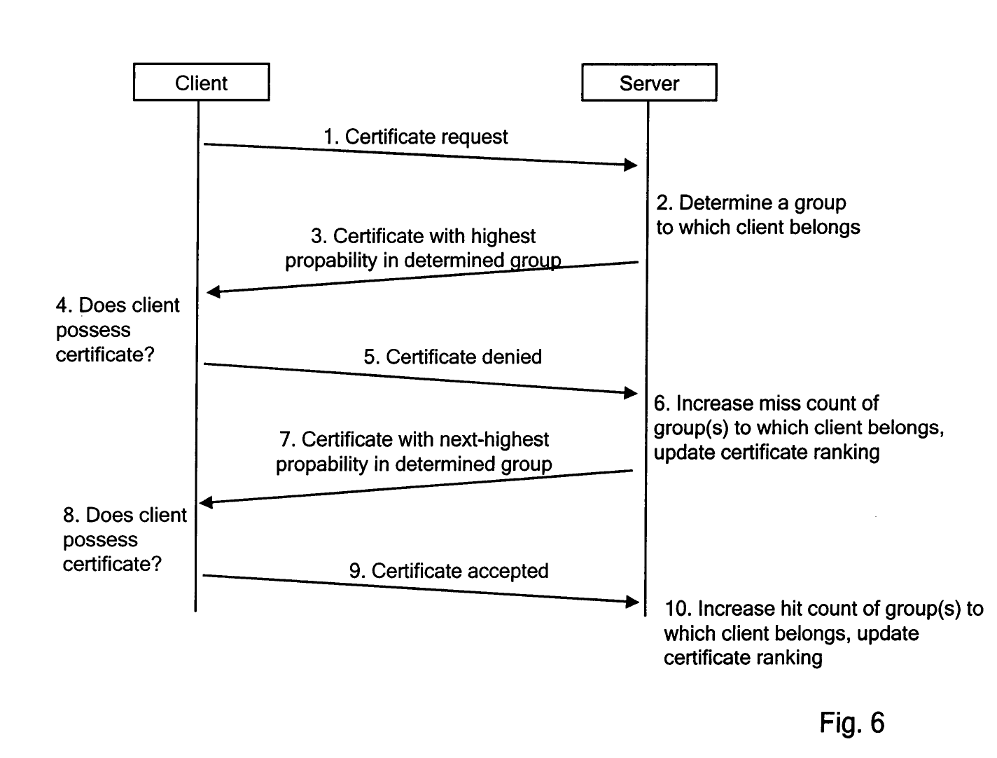

FIG. 6 shows a signaling diagram of an authentication process according to the embodiment of the invention. In a communication 1, a client sends a certificate request to a server e.g. in compliance with TLS. Upon receiving such request, the server determines a group to which the client belongs. For example, the clients may be grouped by home address prefix. Hence, the home address prefix of the client is assessed and therefrom the corresponding group is determined. In a following communication 3, the server transmits the certificate with highest probability within the determined group to the client. Then, at the client it is checked whether the received certificate can be accepted. In the present case, the client does not possess the certificate so that a denying acknowledgment is returned to the server in a communication 5. At the server the miss count of the group(s) to which the client belongs is increased and the respective certificate ranking(s) is/are updated accordingly. As mentioned above, in the present case only groups for the home address prefix are organized and the client belongs to only one group so that only the miss count of this group is increased. Then, due to the fact that the certificate has been denied, the certificate with next-highest probability is transmitted to the client in a communication 7. At the client it is again checked whether the now received certificate is present in the client. In the present case the client possesses the certificate so that an accept acknowledgment is returned to the server in communication 9. Consequently, at the server the hit count of the home address prefix group to which the client belongs is increased and the certificate ranking in the group is updated accordingly.

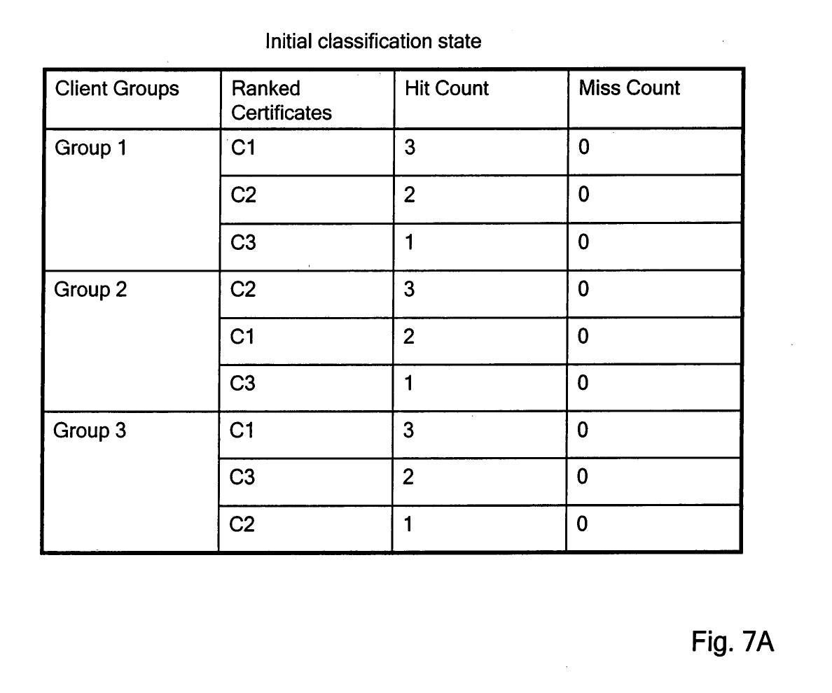

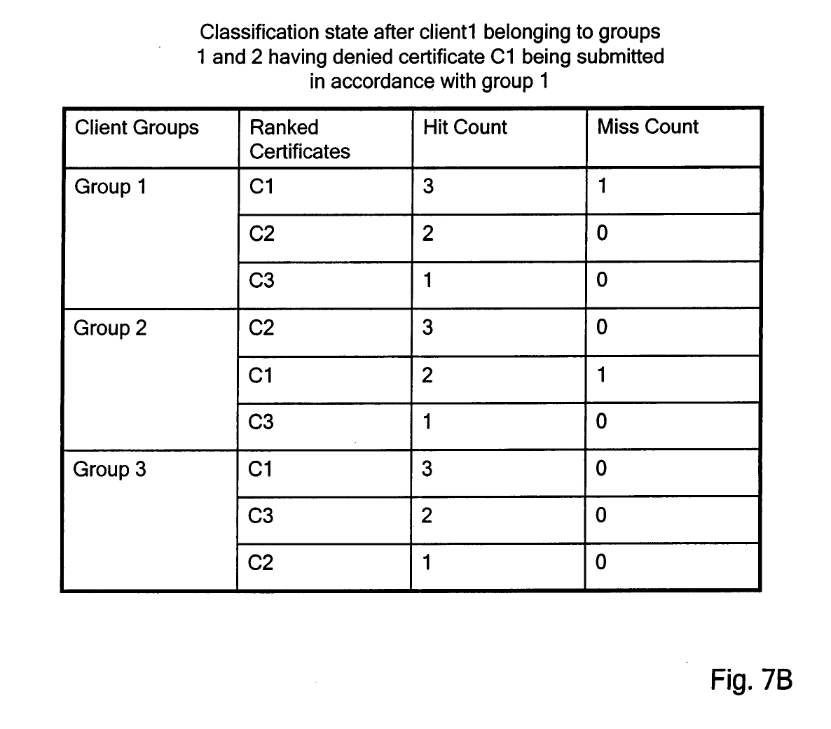

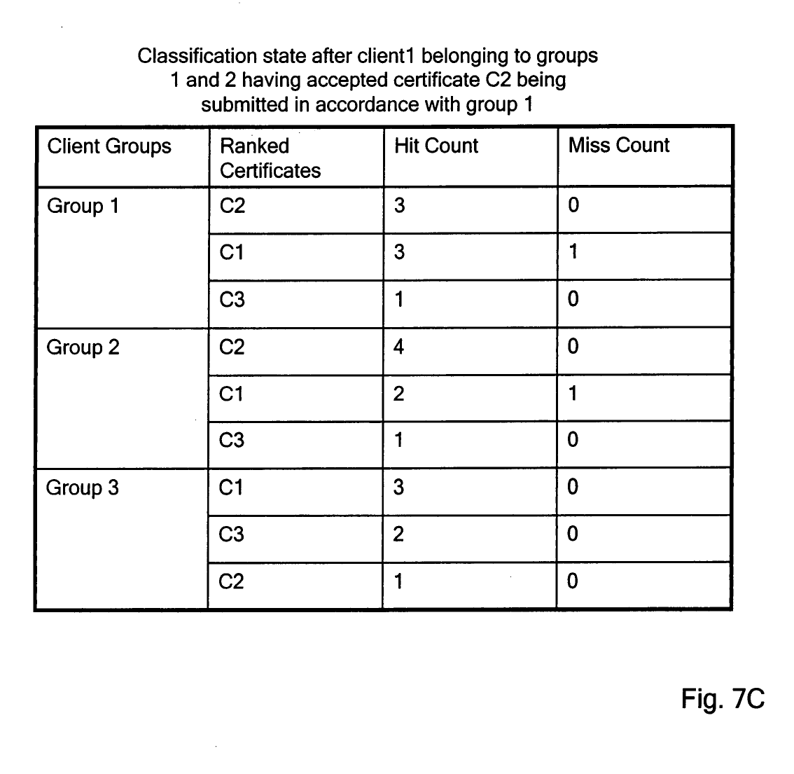

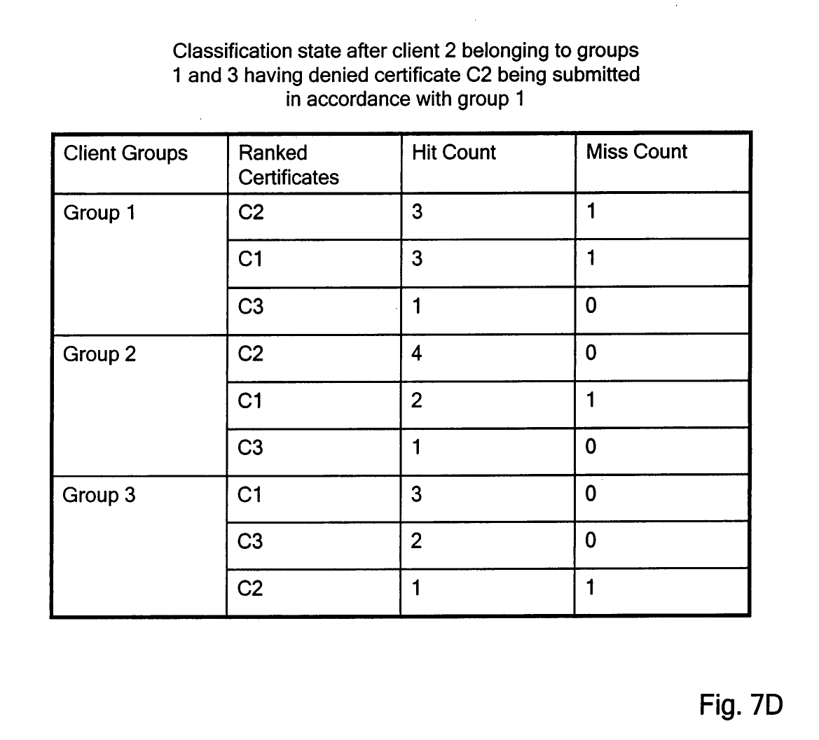

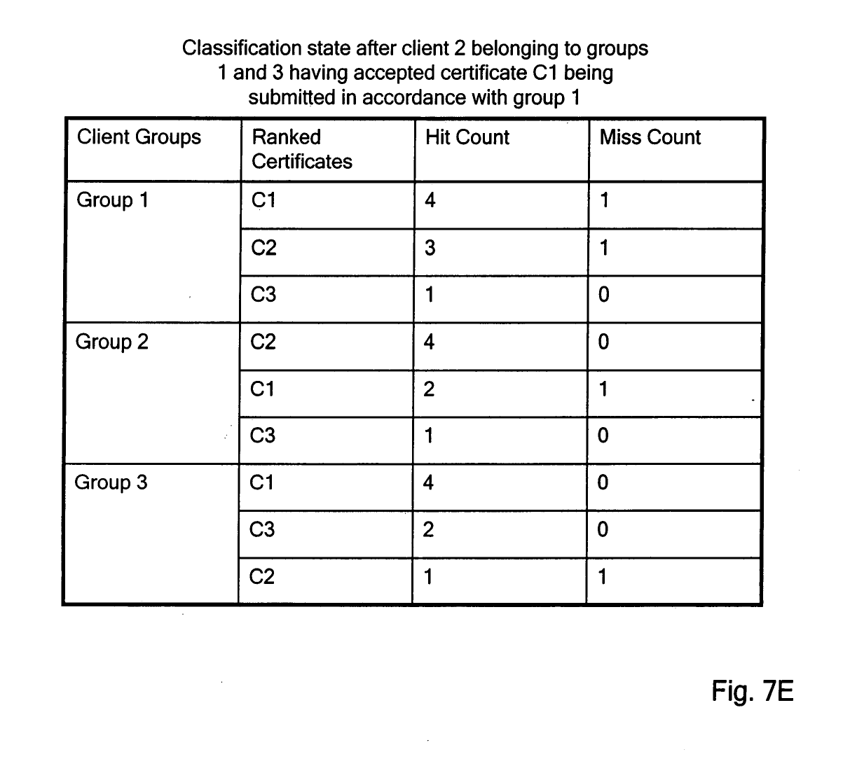

In the following, an example of an implementation of the embodiment will be described with reference to FIGS. 7A to 7E.

In FIG. 7A, an organization of client characteristics groups, ranked certificates and hit and miss counts according to an initial classification state in a server is shown. According to the implementation example, there are three client groups. For example, group 1 represents mobile clients, group 2 represents clients residing in Europe, and group 3 represents clients residing in the United States. The total number of certificates is three. In an initial classification state, the certificates are ranked C1 to C3 in group 1, C2, C1, C3 in group 2, and C1, C3, C2 in group 3 according to hit counts 3, 2, 1 and miss counts of zero. This initial state can be preloaded, so that a hierarchy exists even at time 0, i.e. at the initial classification state of the server. In other words, in the initial classification state the certificates may be ranked in the groups in accordance with probabilities known or tracked in advance.

Now it is assumed that a certificate request from a mobile client 1 residing in Europe is transmitted to the server. In the server it is detected that the client 1 belongs to groups 1 and 2. According to the policy rule used in the server, group 1 is used for determining the certificate with the highest probability. As a result, certificate C1 is transmitted to the client 1. However, the client 1 does not possess C1 and, hence, denies C1. Consequently, the server increments the miss count of C1 in groups 1 and 2 and updates the certificate ranking in groups 1 and 2 accordingly.

The updating result is shown in FIG. 7B. The certificate rankings in groups 1 and 2 remain unchanged since, according to the hit and miss counts, C1 still is the certificate with highest probability in group 1 and the certificate with second highest probability in group 2 according to the applied policy for determining the probabilities. It is to be noted that the certificate probabilities are not necessarily calculated according to “normal probability theory calculations”, but may be calculated based on some specific rules. The probability may be calculated according to certain policy which can change during the classification procedure.

In a next step, since C1 was denied by client 1, the server submits certificate C2 to the client 1 which certificate C2 is the certificate with the next-highest probability in group 1. As the client accepts C2, the hit count for C2 in groups 1 and 2 is incremented and the certificate ranking in groups 1 and 2 is updated in accordance with the hit and miss counts. In the present case, C2 shifts to the top of the ranking in group 1 and remains on top in group 2, which is shown in FIG. 7C. Alternatively, another policy can be used for determining the hit probability such that e.g. only the hit counts are considered so that in group 1 the certificate C1 may stay on top of the ranking.

Now it is assumed that a mobile client 2 residing in the US transmits a certificate request to the server. At the server it is detected that the client 2 belongs to groups 1 and 3. According to the policy rule the server determines the certificate with the highest probability for the client 2 from group 1, i.e. according to FIG. 7C C2 is submitted to the client 2. However, the client 2 does not possess C2, so that the miss count for C2 is incremented in groups 1 and 3 at the server. Subsequently, the certificate ranking is updated in accordance with the hit and miss counts or the hit probability determined from the hit and miss counts. In group 1, now the certificate C2 has the same number of hit and miss counts as the certificate C1. However, the certificate rankings in both groups 1 and 3 remain unchanged as shown in FIG. 7D. In a next step the server submits the certificate C1 to the client 2 since C1 is the second probable one in the ranking of group 1. The client accepts C1 so that the hit counts for C1 in groups 1 and 3 are incremented and the rankings in groups 1 and 3 are updated correspondingly. The result is shown in FIG. 7E in which the ranking in group 3 is confirmed with respect to FIG. 7D and in the ranking in group 1 now C1 has become again the certificate with highest probability.

It is to be noted that the invention is in no way limited by the above implementation example. For instance, in further or alternative implementations characteristics groups may be joined together, certain certificates may be assigned only to specific groups or hit/miss counts may be incremented only for the policy rule group(s). Furthermore, the policy rule may be changed during the classification procedure.

In summary, according to a preferred embodiment of the invention, clients are organized into groups (for instance, fixed vs. mobile, or grouping the clients by home address prefix, or by the application being used). Within each group, the certificates are ranked by their likelihood of being possessed by a client in the group. For each certificate request, the certificates are presented by order of likelihood, and the certificate hit/miss ratio within the groups is updated dependent on whether the client accepts or denies the respective certificate.

It is to be understood that the above description is illustrative of the invention and is not to be construed as limiting the invention. Various modifications and applications may occur to those skilled in the art without departing from the true spirit and scope of the invention as defined by the appended claims.

What is claimed is:

1. A method of authenticating an entity in a communication network system, comprising the steps of:
providing certificates of a first entity to be authenticated by a second entity on the basis of a certificate common to the first and second entities;
classifying the certificates of the first entity as a function of probability that a second entity includes a given certificate; and
in response to a certificate request by a second entity, submitting the classified certificate with highest probability to the second entity.

2. The method according to claim 1, wherein in case the certificate with highest probability is not present in the second entity, at least one further classified certificate is submitted to the second entity by decreasing likelihood, starting with the certificate with next-highest probability.

3. The method according to claim 1, wherein the classified certificates are evaluated on the basis of whether or not a submitted certificate is present in the second entity and classification of the certificates is updated on the basis of the evaluation result.

4. The method according to claim 1, wherein for classifying the certificates second entities are organized into groups, and within each group the certificates are ranked by their likelihood of being present in a second entity in the group.

5. The method according to claim 2, wherein for classifying the certificates second entities are organized into groups, and within each group the certificates are ranked by their likelihood of being present in a second entity in the group.

6. The method according claim 3, wherein for classifying the certificates second entities are organized into groups, and within each group the certificates are ranked by their likelihood of being present in a second entity in the group.

7. The method according to claim 4, wherein for each group a hit count is maintained with each certificate in the group, and if a certificate is submitted to a second entity belonging to given groups which certificate is present in the second entity, the hit count for each given group is increased, and on the basis of the hit counts the certificates are determined and ranked.

8. The method according to claim 4, wherein for each group a miss count is maintained with each certificate in the group, and if a certificate is submitted to a second entity belonging to given groups which certificate is not present in the second entity, the miss count for each given group is increased, and on the basis of the miss counts the certificates are determined and ranked.

9. The method according to claim 7, wherein for each group a miss count is maintained with each certificate in the group, and if a certificate is submitted to a second entity belonging to given groups which certificate is not present in the second entity, the miss count for each given group is increased, and on the basis of a hit probability derived from the hit counts and the miss counts the certificates are determined and ranked.

10. The method according to claim 4, wherein the second entities are arranged into groups based on at least one of the aspects of mobility, number of certificates present in the second entity, geographical information, prefix information and application information.

11. The method according to claim 7, wherein the second entities are arranged into groups based on at least one of the aspects of mobility, number of certificates present in the second entity, geographical information, prefix information and application information.

12. The method according to claim 8, wherein the second entities are arranged into groups based on at least one of the aspects of mobility, number of certificates present in the second entity, geographical information, prefix information and application information.

13. The method according to claim 9, wherein the second entities are arranged into groups based on at least one of the aspects of mobility, number of certificates present in the second entity, geographical information, prefix information and application information.

14. The method according to claim 4, wherein in response to a certificate request by a second entity the group to which the second entity belongs is determined according to a policy rule and certificates are submitted to the second entity based on the ranked certificates within the group.

15. The method according to claim 7, wherein in response to a certificate request by a second entity the group to which the second entity belongs is determined according to a policy rule and certificates are submitted to the second entity based on the ranked certificates within the group.

16. The method according to claim 8, wherein in response to a certificate request by a second entity the group to which the second entity belongs is determined according to a policy rule and certificates are submitted to the second entity based on the ranked certificates within the group.

17. The method according to claim 9, wherein in response to a certificate request by a second entity the group to which the second entity belongs is determined according to a policy rule and certificates are submitted to the second entity based on the ranked certificates within the group.

18. The method according to claim 10, wherein in response to a certificate request by a second entity the group to which the second entity belongs is determined according to a policy rule and certificates are submitted to the second entity based on the ranked certificates within the group.

19. An entity of a communication network system, comprising:
storage means for storing certificates of the entity to be authenticated by another entity of the communication network system based on a certificate common to both entities;
classification means for classifying the certificates of the entity as a function of probability that another entity includes a given certificate; and
in response to a certificate request by another entity, submission means for submitting the classified certificate with highest probability to the other entity.

20. The entity according to claim 19, wherein the entity is a serving network node of the communication network system.

21. The entity according to claim 19, wherein the other entity is a terminal of the communication network system.

22. A computer program product comprising software code portions for performing the steps, when run on a computer of:
providing certificates of a first entity to be authenticated by a second entity on the basis of a certificate common to the first and second entities;
classifying the certificates of the first entity as a function of probability that a second entity includes a given certificate; and
in response to a certificate request by a second entity, submitting the classified certificate with highest probability to the second entity.

23. The computer program product according to claim 22, wherein the product comprises a computer-readable medium on which the software code portions are stored.

24. The computer program product according to claim 22, wherein the product is directly loadable into the internal memory of the computer.
